(19) United States
(12) Patent Application Publication
(10) Pub. No.: US 2005/0069663 A1
(43) Pub. Date: Mar. 31, 2005

(54) Method for storing polymer

(76) Inventor: John M. Morgan, Schenectady, NY (US)

Correspondence Address: CANTOR COLBURN, LLP, 55 GRIFFIN ROAD SOUTH, BLOOMFIELD, CT, 06002, US

(21) Appl. No.: 10/950,103

(22) Filed: Sep. 24, 2004

Related U.S. Application Data
(60) Provisional application No. 60/507,341, filed on Sep. 30, 2003.

(51) Int. Cl. F16L 1/00

(52) U.S. Cl. 428/35.7

(57) ABSTRACT

A method for packaging a polymer comprises introducing the polymer to a container through an opening. A moisture barrier is disposed over the opening, wherein the moisture barrier is configured to rupture at a selected pressure differential across the moisture barrier, and a change in moisture content of the polymer is maintained to less than or equal to about 0.5 wt %, based upon the total weight of the polymer.

### CROSS REFERENCE TO RELATED APPLICATION

This application claims the benefit of U.S. Provisional application Ser. No. 60/507,341 filed Sep. 30, 2004, the contents of which are incorporated herein, in their entirety.

### BACKGROUND OF THE INVENTION

Railway hopper cars, used for transporting polymers in bulk, are generally unloaded by applying a vacuum conveying line to an outlet gate positioned at the bottom of each car compartment. As can be appreciated, the top of the car compartment must be vented to compensate for material drawn out the bottom of the compartment. Failure to vent the top of the compartment would reduce the efficiency of the vacuum unloading process and would result in a negative pressure that could cause the car or the compartment to collapse. To simplify the pellet removal, vented hopper cars have been employed for most bulk polymer deliveries.

The opening of hatch covers involves several problems. Firstly, some means permitting access to the top of the railway car must be provided. One possibility is to attach ladders and platforms to the car, which a worker may use to climb onto the top of the car. Alternatively, the unloading facility may have a gantry or the like, providing access to the top of the railway car. Either of these methods unduly complicates the necessary facilities. Secondly, open hatches tend to invite security problems like a risk of contaminating the lading due to the open hatch.

Simplified methods and apparatus for delivering bulk quantities of high quality polymers to customers are continuously sought.

### SUMMARY OF THE INVENTION

The present disclosure is a method for packaging a polymer. In one embodiment, the method for packaging a polymer comprises introducing the polymer to a container through an opening. A moisture barrier is disposed over the opening, wherein the moisture barrier is configured to rupture at a selected pressure differential across the moisture barrier. A change in moisture content of the polymer is maintained to less than or equal to about 0.5 wt %, based upon the total weight of the polymer.

In another embodiment, the method for packaging a polymer comprises: introducing the polymer to a container through an opening, disposing a hatch over the opening, and disposing a moisture barrier between the opening and an environment external to the container. The moisture barrier is configured to rupture at a selected pressure differential across the moisture barrier. A change in moisture content of the polymer is less than or equal to about 0.5 wt %, based upon the total weight of the polymer.

In one embodiment, a method for transporting polyarylene ether comprises: disposing the polyarylene ether in a container through an opening, disposing a moisture barrier over the opening, applying a vacuum to the container at an outlet, rupturing the moisture barrier, and removing the polyarylene ether from the container. A change in moisture content of the polyarylene ether while it is in the container is less than or equal to about 0.5 wt %, based upon the total weight of the polyarylene ether.

The above described and other features are exemplified by the following figures and the detailed description.

### DETAILED DESCRIPTION

Polymer resins are typically delivered to customers in the form of pellets, powders, and granules. These resins can be packaged in moisture proof bags to prevent moisture contamination, particularly when the polymers are hygroscopic. Resins are hygroscopic to varying degrees and can absorb moisture at levels as high as 2 percent depending on their environment. Moisture absorption is a major source for contamination of hygroscopic polymers. The presence of moisture in these resins may lead to secondary finishing defects such as splay and variations in viscosity. Variations in viscosity can affect the molding behavior of the resins. The splay and viscosity issues can lead to low finishing products.

In order to maintain a very low level of moisture, packaging having a very low water permeation level is employed. Packaging is often a multi-layer structure. An example of a three-layer structure for packaging is an aluminum foil layer sandwiched between two plastic layers. These packagings have sufficient moisture barrier properties to maintain very low moisture levels in the packaged resin materials. A disadvantage of packaging bags lined with moisture barrier material is that this packaging is suitable for small volume pellet customers. These bags can hold only up to about 25 kilograms in per bag. Aluminum bags lined with moisture barrier material can hold a maximum weight of about 600 kilograms. This is again suitable for small volume customers. When the volume demanded by customers is large, the pellets or granules need to de delivered in trucks or railcars (e.g., at weights of greater than or equal to about 2,000 kilograms (kg). Eliminating moisture contamination in trucks, railcars, and cargo containers has been a difficult challenge to the plastic industry, particularly when the transportation time is more than a week and relative humidity is high (e.g., greater than or equal to about 50 percent).

Supplying hygroscopic polymers with effective moisture control to large volume pellet customers is a problem and thus there continues to be a need for improved methods for packaging and transporting hygroscopic resins. It would thus be desirable to have a moisture barrier that may be used with a vented hatch that provides a moisture barrier function until the container is ready to be unloaded but does not have to be removed before unloading the container.

Presence of moisture in polymers leads to secondary finishing defects such as splay, and can cause a large variation in viscosity. Secondary finishing is any finishing that must be performed on a molded part before it can be considered usable for its designed purpose. Splay or silver streaking is a typical secondary finishing defect. Splay marks are tracks caused by gas or liquid present or trapped in a material, migrating to the surface of the mold, which then may slide over the surface in the direction of flow or towards a vent, leaving tracks.

A method for packaging and transporting a bulk amount of polymer, particularly hygroscopic polymer, comprises the use of a breakaway barrier on the opening of a railway car, truck, cargo container, or the like capable of holding greater than or equal to about 2,000 kg of the polymer (hereinafter referred to as container). The polymer is disposed in the container, wherein the container comprises a main body comprising an opening and an outlet. The container further comprises a vented hatch disposed over the opening, with a moisture barrier material disposed between the container and an environment external to the container (e.g., between the vented hatch and the opening). During unloading, a vacuum is applied to the container at the outlet, rupturing the moisture barrier, and removing the polymer from the container.

The bulk shipment of hygroscopic polymers has always been a challenging job. The container used for the shipment of hygroscopic polymers is generally unloaded by applying a vacuum conveying line to an outlet gate positioned at or near the bottom of each container (e.g., railway hopper car compartment). The top of the container is vented to improve the efficiency of the vacuum unloading process and to prevent a negative pressure within the container during unloading. By employing a breakaway barrier between the vented hatch and the container opening, moisture can be prevented from entering the container, yet the container can be readily unloaded since the barrier breaks away upon the application of the vacuum to remove the polymers.

The moisture barrier layer is fabricated to rupture at a selected pressure when vacuum is applied for unloading the container. This barrier inhibits moisture from entering the container such that an increase in polymer moisture content from the time of loading to unloading (e.g., while the polymer is in the container) can be maintained at less than or equal to about 0.5 weight percent (wt %), with less then or equal to about 0.2 wt % readily attainable, based upon the total weight of the polymer. Essentially, a polymer moisture content can be maintained at less than or equal to about 0.5 wt %, based upon the total weight of the polymer. Unless specified otherwise, all moisture content set forth herein is measured at about 25° C.

An exemplary vented hatch is described in U.S. Pat. Nos. 5,064,089A and 5,794,539. The hatch cover may be made from any material compatible with the environment in which the container will be used (e.g., sun, rain, snow, sea salt, etc.).

In order to prevent moisture from entering the container, a breakaway moisture barrier is disposed between the hatch and the opening. In other words, the vented hatch is disposed over the moisture barrier, on a side of the moisture barrier opposite the polymer (e.g., pellets). The material for the moisture barrier layer should have sufficient structural rigidity and strength so that it does not tear in handling when placed over the opening in the container; e.g., when, in the form of a bonnet, fit over the container opening, but will rupture when a vacuum is applied to withdraw the polymer from the container. When the vacuum begins, a pressure differential develops across the barrier, causing the barrier to rupture. The desired material and moisture barrier design are chosen based upon the desired rupture pressure, and preferably the ability to rupture without dislodging from the opening or breaking into pieces. For many applications, a rupture pressure differential is one that is sufficient to combine structural integrity for handling and installing the barrier and ensuring structural integrity until removal of the polymer from the container, while enabling rupturing of the barrier before any damage to the container and/or polymer.

Optionally, the moisture barrier material can have a grain structure that will assist in attaining the desired structural integrity and rupture characteristics. For example, vertically blown polyethylene inhibits moisture from entering into the compartment, yet will rupture (e.g., along its grain lines) at pressure differentials sufficient to provide entry of sufficient air during the vacuum unloading process (e.g., about 0.0625 pound per square inch to about 0.1275 pound per square inch). Other possible barrier materials include polyester and nylon (e.g., spunbond nylon), such as those commercially available from Salco Products, Inc., Tomball, Tex.

Barrier properties arise from both the structure and the composition of the material. The order of the structure, that is, the crystallinity or the amorphous nature of the material, the presence of adsorbents and the existence of layers or coatings may affect the barrier properties. The barrier property of many materials may be increased by using liquid crystal or self-ordering molecular technology, by axially orienting materials such as an ethylene vinyl alcohol film, or by biaxially orienting polypropylene films. Moreover, the higher the level of polymer crystallinity, the lower will be the moisture vapour transmission rate; thus imparting better moisture barrier properties. Copolymer materials, polymer alloys, coatings such as silica, metals, and/or organometallics may be used in/on the moisture barrier to improve the moisture barrier properties.

The geometry of the moisture barrier can be any design capable of inhibiting water from entering the container and preferably capable of rupturing without dislodging from the opening (e.g., fragments of the barrier do not fall into the polymer). Possible geometries include a film or layer having a size larger than the opening size and an attachment mechanism around its periphery such that it can be attached to the opening. Alternatively, the film or layer can merely be secured to the opening by the vented hatch.

The method for transporting (or just storing) a bulk amount of polymer (e.g., polyarylene ethers, polyphenylene ethers, polyamides, and other hygroscopic polymers, as well as copolymers and combinations comprising at least one of the foregoing polymers), therefore, comprises disposing the polymer into a container through an opening. Disposing a moisture barrier over the opening and disposing a hatch over the moisture barrier. Alternatively, the moisture barrier can first be attached to the hatch, in an area at least equivalent to the area adjacent to the opening, or an area that at least covers the vents of the hatch so as to inhibit the introduction of moisture to the container.

Optionally, the barrier can be disposed on a side of the hatch opposite the opening if it can be securely attached to the hatch and/or opening to prevent moisture from entering the container. For example, the moisture barrier can be a layer that merely attaches over the vent openings in the hatch.

It was discovered that, when hygroscopic polymers were disposed in a railway car and allowed sit in the rail yard awaiting transport, the quality of the polymer (e.g., its properties) deteriorated. After substantial investigation, including attempting to dry the polymer upon arrival to the customer site, it was discovered that, if the original polymer moisture level could be maintained or at least retained at less than or equal to about 0.5 wt %, based upon the total weight of the polymer (without the use of multi-layer bags), an improved polymer was received by the customer. Since drying the polymer at the customer site was not totally ineffective, and was inefficient, an alternative was needed.

For simplicity, reduced labor, and the like, the hatches on the rail hopper cars had been replaced with vented hatches to allow removal of the interior product without manual opening of the hatch. This advance, however, enabled access of moisture (both humidity and rain), access to the interior of the container. To prevent the entrance of the moisture, a moisture barrier was disposed over the opening of the container. The moisture barrier (a polyester bonnet from Salco Products, Inc.), was able to maintain a change in moisture content in the polymer (as used herein, “change in moisture content” refers to the moisture content upon being disposed in the container versus the moisture content upon removal from the container) to less than or equal to about 0.5 wt %, with a change in moisture content of less than or equal to about 0.25 wt % readily attainable. As used herein, weight percent is always based upon the total weight of the polymer unless otherwise specified.

By using the present method for packaging and transportation the moisture content of the pellets may be maintained at less than or equal to about 0.5 wt %, even after exposure to relative humidity of greater than or equal to about 80 percent at temperatures of about 25° C. to about 49° C. This method is effective even when the shipment time is greater than or equal to about 14 days. This method reduces problems associated with large shipments of polymer than can not be disposed in a bulk bag, such as shipments of greater than or equal to about 2,000 kg, or, more specifically, greater than or equal to about 40,000 kg, and, even more specifically, greater than or equal to about 50,000 kg of polymer (e.g., polyarylene). For example, the present method can allow transportation of pellets using a pellet rail car that can hold about 5,500 cubic feet (ft³; about 156 cubic meters (m³)) to about 6,000 ft³ (about 170 m³) and up to about 190,000 lbs (about 86,000 kg) of pellets, without moisture damage to the pellets.

For example, a method for transporting polyarylene ether comprises disposing the polyarylene ether in a container (i.e., railway car, cargo container, truck, or the like, (not in a moisture resistant bag)) through an opening. A moisture barrier is disposed over the opening of the container, wherein the moisture barrier is configured to rupture at a selected pressure differential across the moisture barrier. When removal of the product from the container is desired, a vacuum is applied to the container at an outlet such that the moisture barrier ruptures and the polyarylene ether is removed from the container.

Another benefit of the present method is improved melt flow index for the hygroscopic polymer. The melt flow index measures the rate of extrusion of thermoplastics through an orifice at a prescribed temperature and load. The melt flow index value is calculated as the quantity of the polymer in grams flowing through an extruder per 10 minutes. The melt flow index is a useful tool for measuring the flow of a melted material, which can be used to determine the extent of degradation of plastic. Degraded materials will flow more due to the reduced molecular weight and thus the melt flow index value of degraded materials will be more and therefore it will have a lower melt viscosity.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for packaging a polymer, comprising:
introducing the polymer to a container through an opening, wherein the container is capable of receiving greater than or equal to about 2,000 kg of the polymer; and
disposing a moisture barrier over the opening, wherein the moisture barrier is configured to rupture at a selected pressure differential across the moisture barrier;
wherein a change in moisture content of the polymer is less than or equal to about 0.5 wt %, based upon the total weight of the polymer.

2. The method of claim 1, further comprising disposing a vented hatch over the opening.

3. The method of claim 2, further comprising disposing the moisture barrier between the hatch and the opening.

4. The method of claim 1, wherein the polymer is selected from the group consisting of polyarylene ether, polyamide, and copolymers and combinations comprising at least one of these polymers.

5. The method of claim 1, further comprising applying a vacuum to an outlet of the container, rupturing the moisture barrier, and removing the polymer from the container.

6. The method of claim 5, wherein the ruptured moisture barrier does not fall into the polymer.

7. The method of claim 1, wherein the container is selected from the group consisting of a railway hopper car, truck, and cargo container.

8. The method of claim 7, wherein the hygroscopic polymer has an initial melt flow index when disposed in the container and a subsequent melt flow index when removed from the container, and wherein the initial melt flow index is greater than or equal to the subsequent melt flow index.

9. The method of claim 1, wherein the polymer moisture content is less than or equal to 0.2 percent by weight, based upon the total weight of the hygroscopic polymer after exposure to a relative humidity of greater than or equal to about 80% at temperatures of about 27° C. to about 49° C., for greater than or equal to about 14 days.

10. The method of claim 1, wherein the change in moisture content is less than or equal to about 0.25 wt %.

11. A method for transporting a polyarylene ether, comprising:
disposing the polyarylene ether in a container through an opening, wherein the container is capable of receiving greater than or equal to about 2,000 kg of the polymer;
disposing a moisture barrier over the opening;
applying a vacuum to the container at an outlet;
rupturing the moisture barrier; and
removing the polyarylene ether from the container;
wherein a change in moisture content of the polyarylene ether while it is in the container is less than or equal to about 0.5 wt %, based upon the total weight of the polyarylene ether.

12. The method of claim 11, wherein the container is selected from the group consisting of a railway hopper car, truck, and cargo container.

13. The method of claim 11, further comprising disposing a vented hatch over the opening.

14. The method of claim 13, further comprising disposing the moisture barrier between the hatch and the opening.

15. The method of claim 11, wherein the change in moisture content is less than or equal to about 0.25 wt %.

16. A method for packaging a polymer, comprising:
introducing the polymer to a container through an opening;
disposing a hatch over the opening; and
disposing a moisture barrier over the opening, between the opening and an environment external to the container, wherein the moisture barrier is configured to rupture at a selected pressure differential across the moisture barrier;
wherein a change in moisture content of the polymer is less than or equal to about 0.5 wt %, based upon the total weight of the polymer.

17. The method of claim 16, wherein the moisture barrier is disposed between the hatch and the opening.
